(19) United States
(12) Patent Application Publication
(10) Pub. No.: US 2009/0254488 A1
(43) Pub. Date: Oct. 8, 2009

(54) Tax hedging financial instrument and trading platform

(76) Inventor: Ilan Huberman-Shlaes, Chicago, IL (US)

Correspondence Address: Paul E Schaafsma;NovusIP, LLC., Suite 221, 521 West Superior Street, Chicago, IL, 60610, US

(21) Appl. No.: 12/080,734

(22) Filed: Apr. 4, 2008

(51) Int. Cl. G06Q 40/00

(52) U.S. Cl. 705/36 R; 705/36 T

(57) ABSTRACT

In accordance with the principles of the present invention, financial instruments to hedge in future tax rates are provided. The financial instrument comprises a financial contract that obligates a buyer and a seller to settle the financial contract at a price determined for an effective time period such as an effective date. The price of the financial contract is determined based on a tax rate. In a further aspect of the present invention, methods of trading such financial instruments are provided.

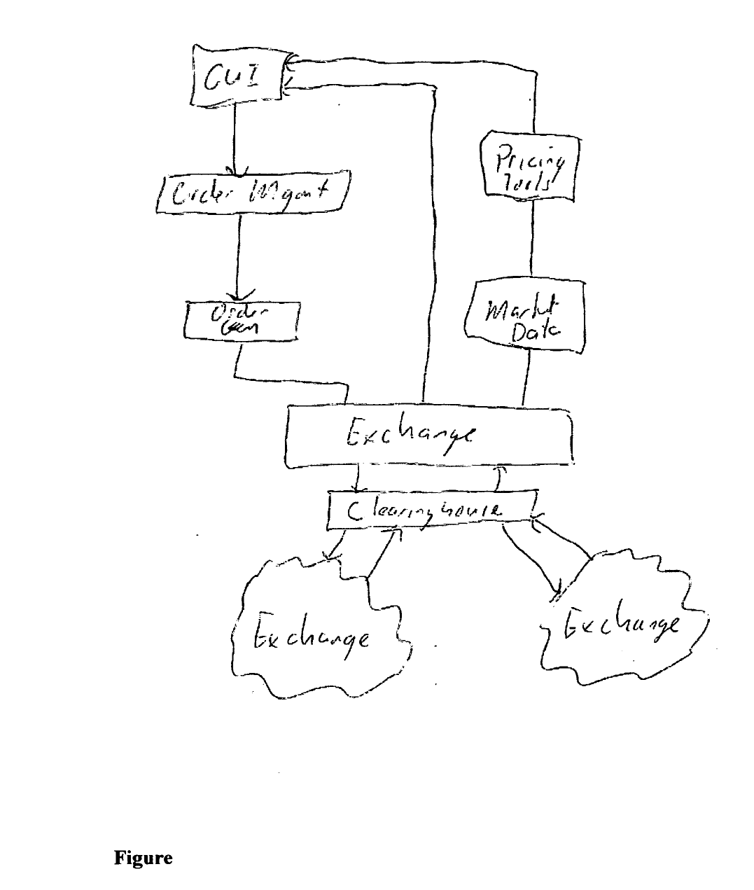

### FIELD OF THE INVENTION

The present invention relates to financial instruments and trading platforms.

### BACKGROUND OF THE INVENTION

Future tax liabilities account for one of the greatest unpaid future financial liabilities facing taxable entities, such as for example individuals, corporations, limited liability companies, partnerships, etc., the world over. And since future tax rates are uncertain, future tax liabilities also are uncertain. Even the post-tax earnings from a constant earning steam are uncertain since tax rates fluxuate. In fact, this uncertainty probably represents one of the greatest financial risks that is incapable of efficient hedging around the globe.

In other areas of financial risk, financial contracts exist that can be used to hedge such risks. A variety of different types of financial contracts are traded on various commodity exchanges and other markets throughout the world. A cash contract is a sales agreement for either immediate or deferred delivery of the actual commodity. A derivatives contract is a financial instrument, the value of which is linked to the price of an underlying such as a commodity, asset, interest rate, index or the occurrence or magnitude of an event. Typical examples of derivatives contracts include futures, forwards, swaps, and options

Despite the sophistication of the financial markets and its myriad of products, there is no financial instrument that can be used directly to hedge against changes in tax rates. While there are some secondary mechanisms that could theoretically be used to attempt a hedge against changing tax rates, there is no direct way to do so. For example, certain municipal bonds may imply certain future tax rates by assuming a counter-party credit and interest rate; however, the use of these municipal bonds to hedge tax rates is indirect, imprecise, very esoteric, and not tradable.

By further example, one could perhaps buy or sell a derivative product based on a Democratic or Republican candidate on some of the new fledgling trading platforms. Of course, one could also buy or sell assets that will respond to changing tax rates. For example, Microsoft Corporation of Redmond, Wash. (symbol: MSFT) pays many taxes and, if corporate tax rates increase, presumably MSFT stock sells off. Even Keogh, Roth or traditional IRAs theoretically might be used to attempt somehow to create a tax trade off. However, these also are all indirect, imprecise, very esoteric, and not tradable.

Thus, there is no direct way to hedge against changes in tax rates. What would therefore be desirable would be a direct, precise, and tradable way to hedge against changes in tax rates.

### SUMMARY OF THE INVENTION

The present invention provides a direct, precise, and tradable way to hedge against changes in tax rates. In accordance with the principles of the present invention, financial instruments to hedge in future tax rates are provided. The financial instruments of the present invention comprise a financial contract that obligates a buyer and a seller to settle the financial contract at a price determined for an effective time period such as an effective date. The price of the financial contract is determined based on a tax rate. In a further aspect of the present invention, methods of trading such financial instruments are provided.

### BRIEF DESCRIPTION OF THE DRAWINGS

The FIGURE is a schematic of non-limiting example hardware architecture that can be used to run an electronic trading platform that trades financial instruments that hedge in future tax rates in accordance with the present invention.

### DETAILED DESCRIPTION OF A PREFERRED EMBODIMENT

In accordance with the principles of the present invention, financial instruments to hedge in future tax rates are provided. In further aspect of the present invention, methods of trading such financial instruments are provided.

In more detail, tax risks will be directly hedgable using financial instruments of the present invention. Tax hedging financial instruments of the present invention will help protect those facing tax rate uncertainties. As used herein, the term “tax” is used in a broad sense to include not only charges imposed by an authority on persons or property for public purposes that are particularly referred to as a tax, but also such charges by any other name. Examples of such authorities can include, for example, but are not limited to government charges by any level of governing authority around the globe such as for example federal, state or local. Examples of such charges can include, for example, but are not limited to income taxes (federal, state, and local) on individuals and/or corporations (including partnerships, limited liability companies, etc.); capital gain taxes; dividends taxes; accounts receivable taxes; inventory taxes; payroll taxes such as unemployment, workers compensation, Social Security and Medicare/Medicaid; excise taxes; import/export taxes such as tariffs, duties, and levees; value-added taxes (VAT); sales taxes; property taxes; inheritance taxes such as estate taxes; gift taxes; use taxes; services taxes; and the like.

In accordance with the principles of the present invention, financial instruments to hedge in future tax rates comprise a financial contract that obligates a buyer and a seller to settle the financial contract at a price determined for an effective time period such as an effective date. The price is determined based on a tax rate. The tax rate can include the actual observed tax rates or, if those are still uncertain, the then-current market implied tax rates. A financial instrument in accordance with the principles of the present invention can take various forms, including, for example, but not limited to exchange traded products such as securities, futures, options, derivatives, exchange traded funds; over-the-counter products; baskets of the above; and the like.

In addition, while in one embodiment of the present invention the financial contract is a tradable contract having features sufficiently standardized to enable volume trading, in another aspect the present invention can take the form of a contract whose term is customized by the parties thereto that obligates a buyer and a seller to settle the financial contract at a price determined based on a tax rate for an effective time period such as an effective date. For example, a private contract could be entered into between a taxpayer who desires to hedge against a tax risk and another party such as a bank who could be obligated to settle the financial contract at a price determined based on a tax rate for an effective date.

A financial instrument in accordance with the principles of the present invention could provide a cash-settled payout based on either the actual observed tax rates or, if those are still uncertain, the then-current market implied tax rates.

To better understand the financial instruments to hedge in future tax rates of the present invention, a few examples are considered. As these examples make clear, the financial instruments of the present invention have wide reaching benefits. These examples are meant as exemplary and not to narrow the scope of the present invention.

### Example 1

### Individuals

As an example of one aspect of the utility of the financial instruments of the present invention to an individual, assume a doctor expects to earn $250,000/year of taxable income for the foreseeable future. And for the sake of simplicity, also assume that the current marginal tax rate is 20% for income up to $50,000 and 30% thereafter. So this year, the doctor can expect to pay $10,000 in taxes on her first $50,000 in earnings (20% of $50,000) and $60,000 in taxes on the remaining $200,000 (30% of $200,000) for a total of $70,000; however, the doctor faces a future tax risk.

Also, assume marginal tax rates will change from 30%, for example, depending on which party prevails in the future U.S. Presidential and Congressional elections. The change of marginal tax rates from 30% translates into a swing of $2,000 per year for each 1% change in the marginal tax rates.

Currently, there is nothing the doctor can do directly to hedge this exposure; however, with a financial instrument to hedge in future tax rates of the present invention, a ready market would exist to trade expected future marginal tax rates. Assume that such a market for the next year's U.S. marginal individual tax rates is trading around 30%. The doctor could buy a future that would allow her to earn or lose $2000 for each 1% change in the marginal tax rates for the next year. That would allow her to effectively hedge out this future risk for the next tax year. And of course, she could hedge future time periods and different expected earning levels by adjusting duration and size of her hedge.

### Example 2

### Corporations

As an example of another aspect of the utility of the financial instruments of the present invention to corporate entities, consider marginal corporate tax rates. Corporate tax gets a bit more interesting since corporate taxes typically are much larger, and there would be natural buyers of tax rates if a company has significant carry forward net operating losses (NOL's). Say a biotechnology corporation has accrued $500 million in tax losses for R&D but expects to become very profitable starting in two years. The value of those NOL's is a function of tax rates in those future years. So, if future tax rates will be low, the value of the NOL's drop (and vice-versa). If the biotech thinks the market is implying a high marginal tax rate in future years, the biotech might consider using a financial instrument of the present invention to sell those future tax rates today and hedge the value of their NOL's.

### Example 3

### Estate Planning

As an example of another aspect of the utility of the financial instruments of the present invention in estate planning, consider that today's legislative process has created an anomaly that estate taxes will revert to high levels in 2011. Instead of being subject to political uncertainty, perhaps a wealthy family would want to lock in a market tax rate (say above a certain exemption level or tax rate) with a financial instrument of the present invention.

### Example 4

### Other Examples

Further aspects of the present invention can be seen in hedging governmental charges such as is seen in, but not limited to, the following examples. Sales taxes on specific products such as fuel (windfall or otherwise), tobacco, alcohol, etc. could be traded. For example, crude oil prices are hedgable, but the tax portion of crude oil is not. With a financial instrument of the present invention, a trucking company or an airline would be able to hedge fluxuations in tax on fuel (on the federal, state, and local levels too). In addition, some jurisdictions (e.g. France) employ a value added tax (VAT). Corporations are sophisticated enough to gauge the impact on their business based on a change in such taxes. With a financial instrument of the present invention, VAT would be hedgable.

Still further, to reduce risk taxpayers with capital gains should trade with those that have losses. Again, with financial instruments of the present invention, one could trade such tax liability. With respect to property taxes, while the assessed amount cannot be ascertained, often the percentage of that assessment that will be taxed would be hedgable. The list of such examples is virtually boundless. Importantly, in each of these examples whether a trade takes place does not alter how much the government will receive; a trade would just reduce the risk that the tax rates would change.

The natural buyers of a tax hedging financial instrument of the present invention will be anyone who may wish to hedge future tax rates. The natural sellers of a tax hedging financial instrument of the present invention would be taxpayers that have losses expressible in future time periods and government entities. As one example, since the Treasury Department actively trades bonds in the primary and secondary markets, as a method of raising revenues it could also sell marginal tax rates when it perceives attractive tax rates. In addition, there would be speculators as both buyers and sellers. Such speculating would help improve the efficiency and liquidity of trading of a financial instrument to hedge in future tax rates of the present invention.

Also, market participants would be expected to trade a financial instrument to hedge in future tax rates as a way to hedge correlated exposures. For example, if a market participant thinks that marginal tax rates are going up only if a Democrat is elected, then a tax hedging financial instrument of the present invention would be a good way to express or hedge a political risk. For example, if a financial portfolio has exposure to defense contractors (e.g. long Lockheed Martine Corp., 6801 Rockledge Drive, Bethesda, Md. (symbol: LMT)) and the investor is concerned that LMT's earning will weaken under a Democratic administration, the investor could hedge this risk by buying marginal tax rates in the U.S. in the coming years. Such examples are endless.

By allowing taxpayers and government entities to hedge their future tax liability/revenues, a massive financial uncertainty will become hedgable. Thus, the present invention could help reduce trillions of dollars in risk around the globe.

In one aspect of the present invention, financial instruments that hedge in future tax rates can be traded through an exchange. When used herein, the term exchange is meant in its broad sense, to include any organization, association or group which provides or maintains a marketplace where for example securities, options, futures, or commodities can be traded. In one embodiment of the present invention, the exchange can comprise a futures exchange and the financial instruments that hedge in future tax rates can be traded through the futures exchange in an exchange-based trading system. In one embodiment of the present invention, the exchange can comprise a securities exchange and the financial instruments that hedge in future tax rates can be traded through the securities exchange in an exchange-based trading system. In one embodiment of the present invention, the exchange can comprise a registered entity such as a board of trade and the financial instruments that hedge in future tax rates can be traded through the registered entity in a registered entity-based trading system. In one embodiment of the present invention, the financial instruments that hedge in future tax rates can be traded through an over-the-counter trading system.

In one aspect of the present invention, financial instruments that hedge in future tax rates can be traded through an electronic exchange. In one aspect of the present invention, financial instruments that hedge future tax rates can be cleared by a clearinghouse. The clearinghouse would guarantee payment to a buyer of an amount owed to the buyer from a seller as a result of the financial contract. The clearinghouse would further guarantee payment to a seller of an amount owed to the seller from a buyer as a result of the financial contract.

In one embodiment of the present invention, trade data can be transmitted between a buyer and the exchange and between a seller and the exchange via a system of networked computers. Trade data can include information relating to the financial instruments of the present invention. In one embodiment of the present invention, the system of networked computers can comprise a wide area network and trade data can be transmitted between the buyer and the exchange and between the seller and the exchange via the wide area network. In one embodiment of the present invention, the wide area network comprises the Internet and trade data is transmitted between the buyer and the exchange and between the seller and the exchange via the Internet.

Referring now to the FIGURE, a non-limiting example of hardware infrastructure that can be used to run an electronic trading platform that trades financial instruments of the present invention is seen. The application can be run in various configurations. The FIGURE shows the various subsystems that can be a part of this application. These subsystems can include a client graphical user interface (GUI), order management, order generator, market data service, and pricing of the financial instruments that hedge in future tax rates of the present invention. The order management interacts with the client graphical user interface and provides instantiate orders to a trading platform such as an exchange and to the order generator. The order generator automatically sends orders to an exchange. The exchange clears the orders through a clearinghouse, which also can clear orders from other exchanges. The exchange sends order confirmation to the client graphical user interface. The market data receives data from the exchange and sends unprocessed data prices to the pricing of the financial instruments that hedge in future tax rates of the present invention. The pricing sends data about prices and quantities for financial instruments that hedge in future tax rates of the present invention to the client graphical user interface.

When the present description utilizes the terms electronic trading, these terms are meant in a broad sense as encompassing not only an electronic exchange and any designated contract market, derivatives transaction execution facility, electronic trading facility, registered entity such as a board of trade, securities exchange or any future such facility, but also any forum in which tradable objects are traded.

While in one aspect of the present invention financial instruments that hedge in future tax rates can be traded through an electronic exchange, of course financial instruments of the present invention can be traded through more traditional methods such as for example open outcry, over-the-counter or telephonic transactions.

While the invention has been described with specific embodiments, other alternatives, modifications, and variations will be apparent to those skilled in the art. Accordingly, it will be intended to include all such alternatives, modifications and variations set forth within the spirit and scope of the appended claims.

What is claimed is:

1. A financial instrument comprising:
a financial contract that obligates a buyer and a seller to settle the financial contract at a price determined for an effective time period; and
the price of the financial contract determined based on a tax rate.

2. The financial product of claim 1 further wherein the tax is selected from the group comprising income tax, capital gains tax, dividends tax, accounts receivable tax, inventory tax, payroll tax, excise tax, import/export tax, value-added (VAT) tax, sales tax, property tax, inheritance tax, gift tax, use tax, services tax, and combinations thereof.

3. The financial instrument of claim 1 further wherein the effective time period is an effective date.

4. The financial instrument of claim 1 further wherein the tax comprises income tax.

5. The financial instrument of claim 4 further wherein the tax comprises individual income tax.

6. The financial instrument of claim 4 further wherein the tax comprises corporate income tax.

7. The financial instrument of claim 1 further wherein the tax comprises capital gains tax.

8. The financial instrument of claim 1 further wherein the tax comprises value-added (VAT) tax.

9. The financial instrument of claim 1 further wherein the tax comprises sales tax.

10. The financial instrument of claim 1 further wherein the comprises property tax.

11. The financial instrument of claim 1 further wherein the tax comprises estate tax.

12. The financial instrument of claim 1 further wherein the financial instrument comprises an exchange traded product.

13. The financial instrument of claim 12 further wherein the financial instrument is selected from the group comprising a security, a future, an option, a derivative, an exchange traded fund, and combinations thereof.

14. The financial instrument of claim 1 further wherein the financial instrument comprises an over-the-counter product.

15. The financial instrument of claim 1 further wherein the financial instrument comprises a basket.

16. The financial instrument of claim 1 further wherein the financial instrument is cash-settled.

17. The financial instrument of claim 16 further wherein the financial instrument is cash-settled based on the actual observed tax rate.

18. The financial instrument of claim 16 further wherein the financial instrument is cash-settled based on market-implied tax rate.

19. The financial instrument of claim 1 further wherein the financial contract is traded through an exchange.

20. The financial instrument of claim 19 further wherein the exchange comprises a futures exchange.

21. The financial instrument of claim 19 further wherein the exchange comprises a securities exchange.

22. The financial instrument of claim 19 further wherein the exchange comprises a registered entity.

23. The financial instrument of claim 1 further wherein the financial contract is traded through open outcry.

24. The financial instrument of claim 1 further wherein the financial contract is traded over-the-counter.

25. The financial instrument of claim 1 further wherein the financial contract is a private contract.

26. The financial instrument of claim 1 further wherein the financial contract is cleared by a clearinghouse that guarantees payment to a buyer of an amount owed to the buyer from a seller as a result of the financial contract, the clearinghouse further guarantees payment to a seller of an amount owed to the seller from a buyer as a result of the financial contract.

27. The financial instrument of claim 1 further wherein trade data is transmitted between a buyer and an exchange and between a seller and an exchange via a system of networked computers, trade data including information relating to the financial contract.

28. The financial instrument of claim 27 further wherein the system of networked computers comprises a wide area network and trade data is transmitted between the buyer and the exchange and between the seller and the exchange via the wide area network.

29. The financial instrument of claim 27 further wherein the wide area network comprises the Internet and trade data is transmitted between the buyer and the exchange and between the seller and the exchange via the Internet.

30. The financial instrument of claim 1 further wherein the tax is a federal tax.

31. The financial instrument of claim 1 further wherein the tax is a state tax.

32. The financial instrument of claim 1 further wherein the tax is a local tax.

33. The financial instrument of claim 1 further wherein the financial contract is traded through a forum selected from the group comprising a designated financial contract market, a derivatives transaction execution facility, an electronic trading facility, a registered entity, a securities exchange, and any future such facility.

34. A financial product comprising a tradable financial contract that entitles a purchaser to receive, and obligates a seller to pay, a sum of money on a specified future time period, the sum of money determined based on a tax rate.

35. The financial product of claim 34 further wherein the tax is selected from the group comprising income tax, capital gains tax, dividends tax, accounts receivable tax, inventory tax, payroll tax, excise tax, import/export tax, value-added (VAT) tax, sales tax, property tax, inheritance tax, gift tax, use tax, services tax, and combinations thereof.

36. The financial product of claim 34 further wherein the effective time period is an effective date.

37. The financial product of claim 34 further wherein the tax comprises income tax.

38. The financial product of claim 37 further wherein the tax comprises individual income tax.

39. The financial product of claim 37 further wherein the tax comprises corporate income tax.

40. The financial product of claim 34 further wherein the tax comprises capital gains tax.

41. The financial product of claim 34 further wherein the tax comprises value-added (VAT) tax.

42. The financial product of claim 34 further wherein the tax comprises sales tax.

43. The financial product of claim 34 further wherein the comprises property tax.

44. The financial product of claim 34 further wherein the tax comprises estate tax.

45. The financial product of claim 34 further wherein the financial instrument comprises an exchange traded product.

46. The financial product of claim 45 further wherein the financial instrument is selected from the group comprising a security, a future, an option, a derivative, an exchange traded fund, and combinations thereof.

47. The financial product of claim 34 further wherein the financial instrument comprises an over-the-counter product.

48. The financial product of claim 34 further wherein the financial instrument is a basket.

49. The financial product of claim 34 further wherein the financial instrument is cash-settled.

50. The financial product of claim 49 further wherein the financial instrument is cash-settled based on the actual observed tax rate.

51. The financial product of claim 49 further wherein the financial instrument is cash-settled based on market-implied tax rate.

52. The financial product of claim 34 further wherein the financial contract is traded through an exchange.

53. The financial product of claim 52 further wherein the exchange comprises a futures exchange.

54. The financial product of claim 52 further wherein the exchange comprises a securities exchange.

55. The financial product of claim 52 further wherein the exchange comprises a registered entity.

56. The financial product of claim 34 further wherein the financial contract is traded through open outcry.

57. The financial product of claim 34 further wherein the financial contract is traded over-the-counter.

58. The financial product of claim 34 further wherein the financial contract is a private contract.

59. The financial product of claim 34 further wherein the financial contract is cleared by a clearinghouse that guarantees payment to a buyer of an amount owed to the buyer from a seller as a result of the financial contract, the clearinghouse further guarantees payment to a seller of an amount owed to the seller from a buyer as a result of the financial contract.

60. The financial product of claim 34 further wherein trade data is transmitted between a buyer and an exchange and between a seller and an exchange via a system of networked computers, trade data including information relating to the financial contract.

61. The financial product of claim 60 further wherein the system of networked computers comprises a wide area network and trade data is transmitted between the buyer and the exchange and between the seller and the exchange via the wide area network.

62. The financial product of claim 60 further wherein the wide area network comprises the Internet and trade data is transmitted between the buyer and the exchange and between the seller and the exchange via the Internet.

63. The financial product of claim 34 further wherein the tax is a federal tax.

64. The financial product of claim 34 further wherein the tax is a state tax.

65. The financial product of claim 34 further wherein the tax is a local tax.

66. The financial product of claim 34 further wherein the financial contract is traded through a forum selected from the group comprising a designated financial contract market, a derivatives transaction execution facility, an electronic trading facility, a registered entity, a securities exchange, and any future such facility.

67. A method of trading comprising trading a financial contract that obligates a buyer and a seller to settle the contract on a specified future time period, and utilizing a tax rate to determine the price of the financial contract.

68. The method of trading of claim 67 further comprising trading a financial contract that obligates a buyer and a seller to settle the contract on a specified future date, and utilizing a tax rate to determine the price of the financial contract.

69. The method of trading of claim 67 further comprising trading the financial contract through an exchange.

70. The method of trading of claim 69 further comprising trading the financial contract through a futures exchange.

71. The method of trading of claim 69 further comprising trading the financial contract through a securities exchange.

72. The method of trading of claim 69 further comprising trading the financial contract through a registered entity.

73. The method of trading of claim 3.1 further comprising trading the financial contract through a electronic exchange.

74. The method of trading of claim 67 further comprising clearing the financial contract through a clearinghouse that guarantees payment to a buyer of an amount owed to the buyer from a seller as a result of the financial contract, the clearinghouse further guarantees payment to a seller of an amount owed to the seller from a buyer as a result of the financial contract.

75. The method of trading of claim 67 further comprising trading the financial contract through an open outcry trading system.

76. The method of trading of claim 67 further comprising utilizing a tax rate selected from the group comprising income tax, capital gains tax, dividends tax, accounts receivable tax, inventory tax, payroll tax, excise tax, import/export tax, value-added (VAT) tax, sales tax, property tax, inheritance tax, gift tax, use tax, services tax, and combinations thereof.

77. The method of trading of claim 67 further comprising utilizing an income tax rate.

78. The method of trading of claim 77 further comprising utilizing an individual income tax rate.

79. The method of trading of claim 77 further comprising utilizing a corporate income tax rate.

80. The method of trading of claim 67 further comprising utilizing a capital gains tax rate.

81. The method of trading of claim 67 further comprising utilizing a value-added (VAT) tax rate.

82. The method of trading of claim 67 further comprising utilizing a sales tax rate.

83. The method of trading of claim 67 further comprising utilizing a property tax rate.

84. The method of trading of claim 67 further comprising utilizing a estate tax rate.

85. The method of trading of claim 67 further comprising trading an exchange traded product.

86. The method of trading of claim 85 further comprising trading a financial contract selected from the group comprising a security, a future, an option, a derivative, an exchange traded fund, and combinations thereof.

87. The method of trading of claim 67 further comprising trading a basket of financial contracts.

88. The method of trading of claim 67 further comprising cash settling the financial contract.

89. The method of trading of claim 88 further comprising cash settling the financial contract based on the actual observed tax rate.

90. The method of trading of claim 88 further comprising cash settling the financial contract based on market-implied tax rate.

91. The method of trading of claim 67 further comprising transmitting trade data between the buyer and an exchange and between the seller and an exchange via a system of networked computers, trade data including information relating to the financial contract.

92. The method of trading of claim 91 further comprising transmitting trade data between the buyer and an exchange and between the seller and an exchange via a wide area network.

93. The method of trading of claim 91 further comprising transmitting trade data between the buyer and an exchange and between the seller and an exchange via the Internet.

94. The method of trading of claim 67 further comprising utilizing a federal tax rate.

95. The method of trading of claim 67 further comprising utilizing a state tax rate.

96. The method of trading of claim 67 further comprising utilizing a local tax rate.
